(19) United States
(12) Patent Application Publication
(10) Pub. No.: US 2010/0091178 A1
(43) Pub. Date: Apr. 15, 2010

(54) Imaging device housing

(76) Inventors: Marko Eromaki, Tampere (FI); Tommi Tavi, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/251,129

(22) Filed: Oct. 14, 2008

(51) Int. Cl. H04N 5/225

(52) U.S. Cl. 348/373; 348/E05.024

(57) ABSTRACT

This invention relates to a first housing component and a second housing component being configured to be pivot-mounted to the each other. The second housing component comprises a surface portion configured to accommodate an aperture of a camera. The aperture is displaced from the pivot point. Pivoting the first housing component and the second housing component with respect to each other involves a change of the arrangement of a surface portion of the first housing component opposed to the surface portion of the second housing component which is configured to accommodate the aperture of the camera.

### FIELD

This invention relates to concepts for imaging device housings concepts.

### BACKGROUND

Today's electronic devices are often equipped with a camera, e.g. a digital camera. Customers set a high value on these devices' usability. Good user experience is an important selling point and of high interest for the manufacturers of these devices. Comfortable and comprehensible control of these devices is a key element for a good user experience.

In order to meet customer needs, a well designed camera concept has to be employed so as to obtain high quality images. For instance, this goal can be reached with an elaborate lens system and high performance image sensors. These components can be sensitive to mechanical forces. This is an issue in particular with respect to mobile devices that are like to, for example, be accidentally dropped by a user or carried in a bag together with other objects that can cause damage of the device.

Another important task is to keep manufacturing costs of an apparatus that comprises an image acquisition device low.

### SUMMARY OF SOME EXEMPLARY EMBODIMENTS OF THE INVENTION

According to a first aspect of the present invention, a first apparatus is disclosed, comprising a first housing component and a second housing component being pivot-mounted to the first housing component and comprising a surface portion configured to accommodate an aperture of a camera, the aperture being displaced from the pivot point, wherein pivoting the first housing component and the second housing component with respect to each other involves a change of the arrangement of a surface portion of the first housing component opposed to the surface portion of the second housing component which is configured to accommodate the aperture of the camera.

According to the first aspect of the present invention, a second apparatus is disclosed, comprising a first housing component configured to be pivot-mounted to a second housing component comprising a surface portion configured to accommodate an aperture of a camera, the aperture being displaced from the pivot point, wherein pivoting the first housing component and the second housing component with respect to each other involves a change of the arrangement of a surface portion of the first housing component opposed to the surface portion of the second housing component which is configured to accommodate the aperture of the camera.

According to the first aspect of the present invention, a third apparatus is disclosed, comprising a second housing component configured to be pivot-mounted to a first housing component, the second housing component comprising a surface portion configured to accommodate an aperture of a camera, the aperture being displaced from the pivot point, wherein pivoting the first housing component and the second housing component with respect to each other involves a change of the arrangement of a surface portion of the first housing component opposed to the surface portion of the second housing component which is configured to accommodate the aperture of the camera.

According to the first aspect of the present invention, a first method is disclosed, comprising pivoting a first housing component of an apparatus with respect to a second housing component of the apparatus comprising a surface portion configured to accommodate an aperture of a camera, the aperture being displaced from the pivot point and the second housing component being pivot-mounted to the first housing component, wherein pivoting the first housing component and the second housing component with respect to each other involves a change of the arrangement of a surface portion of the first housing component opposed to the surface portion of the second housing component which is configured to accommodate the aperture of the camera.

According to a second aspect of the present invention, a first apparatus is disclosed, comprising housing means and means for accommodating means for transmitting signals to be detected by means for acquiring an image, the means for accommodating the means for transmitting signals to be detected by the means for acquiring an image being pivot-mounted to the housing means and comprising a surface portion configured to accommodate the means for transmitting signals to be detected by means for acquiring an image, the means for transmitting signals to be detected by means for acquiring an image being displaced from the pivot point, wherein pivoting the housing means and the means for accommodating the means for transmitting signals to be detected by the means for acquiring an image with respect to each other involves a change of the arrangement of a surface portion of the housing means opposed to the surface portion of the means for accommodating the means for transmitting signals to be detected by the means for acquiring an image which is configured to accommodate the means for transmitting signals to be detected by the means for acquiring an image.

According to the second aspect of the present invention, a second apparatus is disclosed, comprising housing means configured to be pivot-mounted to means for accommodating means for transmitting signals to be detected by means for acquiring an image comprising a surface portion configured to accommodate the means for transmitting signals to be detected by the means for acquiring an image, the means for transmitting signals to be detected by the means for acquiring an image being displaced from the pivot point, wherein pivoting the housing means and the means for accommodating the means for transmitting signals to be detected by the means for acquiring an image with respect to each other involves a change of the arrangement of a surface portion of the first housing means opposed to the surface portion of the means for accommodating the means for transmitting signals to be detected by the means for acquiring an image which is configured to accommodate the means for transmitting signals to be detected by the means for acquiring an image.

According to the second aspect of the present invention, a third apparatus is disclosed comprising means for accommodating means for transmitting signals to be detected by means for acquiring an image configured to be pivot-mounted to housing means, the means for accommodating the means for transmitting signals to be detected by the means for acquiring an image comprising a surface portion configured to accommodate the means for transmitting signals to be detected by the means for acquiring an image, the means for transmitting signals to be detected by the means for acquiring an image being displaced from the pivot point, wherein pivoting the housing means and the means for accommodating the means for transmitting signals to be detected by the means for acquiring an image with respect to each other involves a change of the arrangement of a surface portion of the housing means opposed to the surface portion of the means for accommodating the means for transmitting signals to be detected by the means for acquiring an image which is configured to accommodate the means for transmitting signals to be detected by the means for acquiring an image.

According to the second aspect of the present invention, a first method is disclosed, comprising pivoting housing means of an apparatus with respect to means for accommodating means for transmitting signals to be detected by means for acquiring an image of an apparatus comprising a surface portion configured to accommodate the means for transmitting signals to be detected by the means for acquiring an image, the means for transmitting signals to be detected by the means for acquiring an image being displaced from the pivot point and the means for accommodating the means for transmitting signals to be detected by the means for acquiring an image being pivot-mounted to the housing means, wherein pivoting the housing means and the means for accommodating the means for transmitting signals to be detected by the means for acquiring an image with respect to each other involves a change of the arrangement of a surface portion of the housing means opposed to the surface portion of the means for accommodating the means for transmitting signals to be detected by the means for acquiring an image which is configured to accommodate the means for transmitting signals to be detected by the means for acquiring an image.

In the following, and unless otherwise stated, whenever it is referred to either the first aspect or the second aspect of the present invention, all apparatuses and methods are of that aspect are referred to.

The housing means according to the second aspect of the present invention may for instance comprise a first housing component, while the means for acquiring an image may for instance comprise a camera. In exemplary embodiments of the second aspect of the present invention, the means for accommodating means for transmitting signals to be detected by means for acquiring an image may comprise a second housing component. The means for transmitting signals to be detected by the means for acquiring an image may for instance comprise an aperture through which signals to be detected by the means for acquiring an image can pass.

According to all aspects of the present invention, there are no limitations with respect to the properties of the first housing component and the properties of the housing means. They can be made of any material and can be manufactured by employing any manufacturing technology although, according to some embodiments of the present invention, the first housing component and the housing means can for instance be made of materials that are especially durable or especially cheap. The terms first housing component and housing means do not necessarily imply that other entities are accommodated by the first housing component or the housing means, although this is of course encompassed by the present invention. Instead, these terms express that the first housing component and the housing means form part of some kind of housing.

It also holds for the second housing component and the means for accommodating means for transmitting signals to be detected by means for acquiring an image that there are no limitations with respect to their properties. They can be made of any material and can be manufactured by employing any manufacturing technology although, according to some embodiments of the present invention, the second housing component and the means for transmitting signals to be detected by means for acquiring an image can for instance be made of materials that are especially durable or especially cheap. In contrast to the first housing component and the housing means, the second housing component is configured to accommodate an aperture of a camera, while the means for accommodating means for transmitting signals to be detected by means for acquiring an image are configured to accommodate means for transmitting signals to be detected by means for acquiring an image.

In the context of the present invention, any type of camera can be used. For example, the camera can be sensitive to visible light or it can be sensitive to infrared (IR) light or ultraviolet (UV) light. In an exemplary embodiment of the first aspect of the present invention, the camera is a digital camera. Digital cameras can be manufactured at comparably low costs. At the same time, they may be capable of acquiring images comprising millions of pixels an exhibit low image noise. Furthermore, digital cameras may have compact measurements making them suitable for application in mobile devices where limited space may be provided to accommodate a camera. A camera can be equipped with any type of sensor technology. Among these sensor technologies, a charge-coupled device (CCD) or a complementary metal-oxide-semiconductor sensor (CMOS sensor) can be used for detecting the respective signals. To obtain a camera capable of acquiring images having natural colours, more than one sensor may be employed. For example, a camera may comprise three CCD or CMOS sensors, each of the sensors having its peak sensitivity at a different wavelength. In a camera sensitive to visible light, for instance, a first sensor may have its peak sensitivity in the red region of the spectrum, a second sensor may have its peak sensitivity in the green region of the spectrum and a third sensor may have its peak sensitivity in the blue region of the spectrum. A camera in the sense of the present invention does not necessarily have to be based on the principle of being configured to acquire an image by detecting incident light. An alternative camera concept uses ultrasonic signals to generate an image. In addition to the above examples, in the context of the present invention a camera can be any device capable of acquiring visual information.

Likewise, the means for acquiring an image according to the second aspect of the present invention can be sensitive to visible light or sensitive to IR light or UV light. The means for acquiring an image in the sense of the present invention do also not necessarily have to be based on the principle of being configured to acquire an image by detecting incident light. An alternative concept for means for acquiring an image involves the use of ultrasonic signals. In addition to the above examples, in the context of the present invention means for acquiring an image can be any device capable of acquiring visual information.

In order to obtain an image by employing a camera with a mode of operation based on the detection of light, light has to strike a light sensitive element, e.g. a sensor. To allow the light to reach the light sensitive element, a light-transmissive element is needed. If, for instance, obtaining an image involves the use of ultrasonic signals, these signals have to reach a sensor capable of detecting them. Thus, an element is needed that is transmissive to ultrasonic signals and allows them to reach a sensor. An element transmissive to the respective type of signal employed in a specific embodiment of the present invention is referred to as an aperture. In an exemplary embodiment of the first aspect of the present invention, the aperture can be a recess in the second housing component. Through this recess signals, such as light or ultrasonic waves, can pass and reach a sensor that is configured to detect them, thus allowing image acquisition. In an embodiment of the present invention in which the mode of operation of the camera is based on detecting light, the aperture can be a recess further comprising a lens system which in turn comprises at least one lens. An advantage of this embodiment is that the quality of an acquired image may be enhanced by the lens system. Furthermore, a lens system may permit focusing of objects located at different ranges form the camera.

In order to obtain an image by employing means for acquiring an image, means for transmitting signals to be detected by the means for acquiring an image can be provided. The signals to be detected by the means for acquiring an image can for example be electromagnetic waves or ultrasonic signals. Just one example of means for transmitting signals to be detected by the means for acquiring an image is an aperture. In case of the mode of operation of the means for acquiring an image being based on detecting light, the means for transmitting signals to be detected by the means for acquiring an image can further comprise a lens system.

According to the first aspect of the present invention, the second housing component comprises a surface portion configured to accommodate an aperture of a camera. There are no limitations regarding the shape of the second housing component. At least at one surface of the second housing component there is provided a surface portion configured to accommodate the aperture. If, for example, the aperture comprises a recess, the portion of the second housing component that recess is located in is the surface portion configured to accommodate the aperture.

According to the second aspect of the present invention, the means for accommodating means for transmitting signals to be detected by means for acquiring an image comprise a surface portion configured to accommodate the means for transmitting signals to be detected by means for acquiring an image. There are no limitations regarding the shape of the second housing component. At least at one surface of the second housing component there is provided a surface portion configured to accommodate the aperture. If, for example, the means for transmitting a signal to be detected by the means for acquiring an image are designed as an aperture comprising a recess, the portion of the means for accommodating the means for transmitting signals to be detected by means for acquiring an image that recess is located in is the surface portion configured to accommodate the means for transmitting signals to be detected by means for acquiring an image.

According to the first aspect of the present invention, the first housing component and the second housing component are pivot-mounted to each other. There is no difference in the expression the first housing component is pivot-mounted to the second housing component and in the expression the second housing component is pivot-mounted to the first housing component. These formulations are synonymic. It is noted that two entities that are pivot-mounted to one another implies that the first entity and the second entity can be rotated with respect to one another around a fixed axis. However, this does not limit the meaning of the term pivot-mounted to the case where said fixed axis is the only permitted axis of rotation. Instead, pivot-mounted merely means that it is possible to rotate the first entity and the second entity with respect to each other around at least one fixed axis and potentially around other axes as well. Thus, it could also be said that the first and the second entity can be rotated with respect to each other around at least one fixed axis. Whenever the term pivoting is used in the following, it is referred to a rotation around a single fixed axis. The meaning of the term pivot-mounted according to the second aspect of the present invention is defined accordingly.

According to the first aspect of the present invention, a surface portion of the first housing component that is opposed to the surface portion of the second housing component that is configured to accommodate an aperture of a camera is a portion of a surface of the first housing component the aperture would face if facing a surface of the first housing component at all. In a specific pivot position, i.e. a position of the first housing component and the second housing component with respect to each other caused by pivoting at least one of the housing components, the aperture might not face a surface of the first housing component, but point, for example, at an object that a user wants to take an image of by means of the camera. Even if the aperture does not face the surface of the first housing component in any pivot position, pivoting of at least one of the first housing component and the second housing component changes the arrangement of a surface portion of the first housing component with respect to the surface portion of the second housing component which is configured to accommodate an aperture of a camera because at least one of the surface portions changes its position.

The aperture of the camera is displaced from the pivot point. Thus, pivoting the first housing component with respect to the first housing component automatically causes the position of the aperture to change with respect to the second housing component. In other words, thinking of the pivot point as the center of a rotation of the first housing component with respect to the second housing component around a fixed axis, one could say that the aperture has to be provided eccentrically.

According to the second aspect of the present invention, the housing means and the means for accommodating means for transmitting signals to be detected by means for acquiring an image are also pivot-mounted to each other. Hence, the above explanations also pertain to these apparatuses and this method if the housing means are thought of as the first housing component, the means for accommodating means for transmitting signals to be detected by means for acquiring an image are thought of as the second housing component and the means for transmitting signals to be detected by means for acquiring an image are thought of as an aperture of a camera.

An advantage of the some exemplary embodiments of the present invention can be that by pivoting the first housing component with respect to the second housing component or by pivoting the housing means with respect to the means for accommodating means for transmitting signals to be detected by means for acquiring an image, the position of an aperture of a camera or the position of means for transmitting signals to be detected by means for acquiring an image can be changed with respect to the first housing component or with respect to the means for accommodating means for transmitting signals to be detected by means for acquiring an image. Thus, additional flexibility in handling the apparatus is provided. Moreover, pivoting can yield a shape of the apparatus better suited for storing an apparatus according to the first aspect or the second aspect of the present invention. For example, and of course depending on the shape of the first housing component and the second housing component or the shape of the housing means and the means for accommodating means for transmitting signals to be detected by means for accommodating an image, in case of the apparatus forming part of a mobile device its shape in a certain pivot position may be more compact. Hence, it can be more easily stored, e.g. in a user's pocket. One may also say that the apparatus then has a pocketable size.

Pivot-mounting a first housing component and a second housing component or housing means and means for accommodating means for transmitting signals to be detected by means for acquiring an image to each other can be achieved by choosing one of a variety of possible coupling technologies. For example a hinge can be used for this purpose.

In an exemplary embodiment according to the first aspect of the present invention, the first housing component is formed as a single part. In an exemplary embodiment according to the second aspect of the present invention, the housing means are formed as a single part. A first housing component or housing means formed as a single part can also be referred to as a monoblock device. An advantage of a first housing component or housing means formed as a single part is that they can be especially durable. This can be beneficial if the first housing component or the housing means form part of a mobile device because it is likely that a mobile device gets accidentally dropped by a user.

In an exemplary embodiment according to all aspects of the present invention, the apparatus forms part of a mobile device. There are no limitations regarding the type of the mobile device. For example, the mobile device can be a handheld game console, a personal digital assistant (PDA), a mobile phone, a digital music player or a global navigation satellite system, e.g. Global Positioning System (GPS), navigation device. According to an exemplary embodiment of the first aspect of the present invention, the first housing component and the second housing component can form part of a mobile device, while according to an exemplary embodiment of the second aspect of the present invention, the housing means and means for accommodating means for transmitting signals to be detected by means for acquiring an image can form part of a mobile device. Mobile devices are often equipped with a camera or means for acquiring an image. Due to customer requests for compact mobile devices, a pivotable second housing component or pivotable means for acquiring an image are beneficial.

According to an exemplary embodiment of the first aspect of the present invention, in a protection pivot position the aperture faces a surface portion of the first housing component. According to an exemplary embodiment of the second aspect of the present invention, in a protection pivot position the means for transmitting signals to be detected by the means for acquiring an image face a surface portion of the housing means. An advantage of the two embodiments of the present invention described above is the protection of the aperture and the means for transmitting signals to be detected by the means for acquiring an image, respectively. The first housing component or the means for accommodating means for transmitting signals to be detected by means for acquiring an image can act as a cover for the aperture or the means for transmitting signals to be detected by means for acquiring an image, thus preventing dust from entering the aperture or the means for accommodating means for transmitting signals to be detected by means for acquiring an image or, if a lens system is employed, protecting the lens system from scratches. In consequence, the lifespan of the camera or the means for acquiring an image can be lengthened, thus increasing customer satisfaction. Not having to provide additional lens protection means, manufacturing and material costs can be lowered. It is noted that although such a pivot position is referred to as a protection pivot position, it is not a precondition for the embodiment presently discussed that the aperture is actually protected in that position. For example, the spacing between the first housing component and the second housing component may be too large for the first housing component to cover the aperture. The term protection pivot position is used because in some embodiments the aperture or the means for transmitting signals to be detected by means for acquiring an image can be protected in such a pivot position.

While the aperture of the camera or the means for transmitting signals to be detected by means for acquiring an image are covered, image acquisition might not be possible. In this case, a device comprising an apparatus according to the present invention is not in an image acquisition mode.

According to an exemplary embodiment of first aspect of the present invention, the second housing component engages in a protection pivot position in which the aperture faces a surface portion of the first housing component. Thus, a pivot position can be provided in which it can be ensured that the aperture and possibly a lens system is protected if the second housing component is fixed in that position. Similar advantages can be achieved according to an exemplary embodiment of the second aspect of the present invention, wherein the means for accommodating means for transmitting signals to be detected by means for acquiring an image engages in a pivot position in which the means for transmitting signals to be detected by the means for acquiring an image face a surface portion of the housing means.

According to an exemplary embodiment of the first aspect of the present invention, in an image acquisition pivot position the aperture protrudes over the outline of the first housing component. According to an exemplary embodiment of the second aspect of the present invention, in a image acquisition pivot position the means for transmitting signals to be detected by means for acquiring an image protrude over the outline of the housing means. An advantage of these two embodiments is that the aperture or the means for transmitting signals to be detected by means for acquiring an image are revealed in an image acquisition pivot position, thus permitting to acquire an image by means of the camera or the means for acquiring an image. Thus, in the pivot position an image acquisition mode can be assumed. It is noted that although such a pivot position is referred to as an image acquisition pivot position, it is not a precondition for the embodiment presently discussed that the image acquisition is actually enabled in that pivot position. For example, the camera may be activated in only some of all possible image acquisition pivot position. The term image acquisition pivot position is used because an image acquisition mode can be assumed in such a pivot position if desired.

According to an exemplary embodiment of the first aspect of the present invention, in a basic pivot position the second housing component does not protrude over the outline of the first housing component. According to an exemplary embodiment of the second aspect of the present invention, in a basic pivot position the means for accommodating means for transmitting signals to be detected by means for acquiring an image do not protrude over the outline of the housing means. An advantage of these two embodiments can be that in such a pivot position an apparatus comprising said second housing component or said means for accommodating means for transmitting signals to be detected by means for acquiring an image can be more compact and thus pocketable. It is noted that although such a pivot position is referred to as a basic pivot position, it is not a precondition for the embodiment presently discussed that the basic position an initial pivot position or that it has to be returned to that basic pivot position before another pivot position has to be assumed. As in some embodiments the pocketable size can be an effect occurring in the basic pivot position, the term basic pivot position is used because it may be that this is the pivot position which is assumed most of the time.

According to an exemplary embodiment of the first aspect of the present invention, in more than one pivot position the aperture protrudes over the outline of the first housing component. According to an exemplary embodiment of the second aspect of the present invention, in more than one pivot position the means for transmitting signals to be detected by means for acquiring an image protrude over the outline of the housing means. An advantage of these two embodiments is that the aperture or the means for transmitting signals to be detected by means for acquiring an image are revealed in more than one pivot position, thus permitting a user to select a pivot position in which an object that the user wants to take an image of by means of the camera or the means for acquiring an image can be captured.

According to an exemplary embodiment of the first aspect of the present invention, there is provided an electrical connection between the first housing component and the second housing component. For instance, such a connection can be realized by employing a micro coaxial cable or a flexible printed circuit cable (FPC cable). An advantage of this embodiment is that, for example, with the first housing component and the second housing component forming part of a battery-powered device, the battery can be disposed in the first housing component and the camera can be supplied with electrical power through the electrical connection between the battery disposed in the first housing component and the camera disposed in the second housing component. At the same time, an electrical connection can be exploited for data exchange between a device disposed in the first housing component and a device disposed in the second housing component. In an exemplary embodiment in which the first housing component comprises a user interface, user commands given via this interface can be forwarded to the camera, for instance to control the camera zoom or to trigger image acquisition. According to an exemplary embodiment of the second aspect of the present invention, there is provided an electrical connection between the housing means and the means for accommodating means for transmitting signals to be detected by means for acquiring an image yielding corresponding advantages.

According to an exemplary embodiment of the first aspect of the present invention, the first housing component is configured to accommodate at least one lens faced by the aperture in a pivot position. According to an exemplary embodiment of the second aspect of the present invention, the housing means are configured to accommodate at least one lens faced by the means for transmitting signals to be detected by means for acquiring in a pivot position. In such a pivot position, an image acquisition mode can be assumed. An advantage of these two exemplary embodiments of the present invention is that by providing a lens, the quality of an acquired image can be enhanced. For example, the lens can be a super macro lens. By using a super macro lens, focusing objects close to the camera is rendered possible. Just two additional examples of other lenses suitable for being employed are a 2× zoom lens and a 3× zoom lens, enabling image acquisition from various distances to the object of which an image is to be obtained.

According to an exemplary embodiment of the first aspect of the present invention, the first housing component is configured to accommodate at least two different lenses faced by the aperture in different pivot positions. According to an exemplary embodiment of the second aspect of the present invention, the housing means are configured to accommodate at least two different lenses faced by the means for transmitting signals to be detected by means for acquiring an image in different pivot positions. For example a super macro zoom lens, a 2× zoom lens and a 3× zoom lens, can be provided faced by the aperture or the means for transmitting signals to be detected by means for acquiring an image in different pivot positions. Thus, a user can select a suitable lens for a given imaging task.

According to an exemplary embodiment of the first aspect of the present invention, the surface portion of the second housing component which is configured to accommodate the aperture of a camera is further configured to accommodate a flash displaced from the pivot point. According to an exemplary embodiment of the second aspect of the present invention, the surface portion of the means for accommodating means for transmitting signals to be detected by means for acquiring an image is further configured to accommodate a flash displaced from the pivot point. An advantage of providing a flash is that image acquisition in dark surroundings becomes possible. With the flash being displaced from the pivot point, by pivoting the first housing component with respect to the second housing component or pivoting the housing means with respect to the means for accommodating means for transmitting signals to be detected by means for acquiring an image, the position of the flash with respect to the first housing component or the means for accommodating means for transmitting signals to be detected by means for acquiring an image is changed.

According to an exemplary embodiment of the first aspect of the present invention, the first housing component is configured to accommodate at least one lens faced by the flash in a pivot position. According to an exemplary embodiment of the second aspect of the present invention, the housing means are configured to accommodate at least one lens faced by the flash in a pivot position. An advantage of providing a lens faced by the flash is that it allows shaping of the cone of light emitted by the flash. For example, a lens that narrows the cone of light can be employed. In consequence, proper lighting of a distant object is rendered possible. To give another example, the lens can also be a lens that widens the cone of light for improved illumination of a close object.

According to an exemplary embodiment of the first aspect of the present invention, the first housing component is configured to accommodate at least two different lenses faced by the flash in different pivot positions. According to an exemplary embodiment of the second aspect of the present invention, the housing means are configured to accommodate at least two different lenses faced by the flash in a different pivot position. Thus, a user can select a suitable lens for a given imaging task.

According to an exemplary embodiment of the first aspect of the present invention, in a pivot position the lens faced by the flash is adapted to the lens faced by the aperture in that pivot position. According to an exemplary embodiment of the second aspect of the present invention, in a pivot position the lens faced by the flash is adapted to the lens faced by the means for transmitting signals to be detected by means for acquiring an image in that pivot position. An advantage of these two embodiments is that selecting a lens through which the image is acquired goes along with selecting an adapted lens for the flash. If, for example, a user wants to acquire an image of a distant object and therefore selects a zoom lens by choosing a corresponding pivot position, the flash can face a lens that narrows the cone of light of the flash in the respective pivot position, thus yielding proper illumination of the distant object.

According to an exemplary embodiment of the first aspect of the present invention, the second housing component is configured to accommodate the flash and the aperture of the camera on different sides of the of the pivot point. The flash and the aperture of the camera are located on different sides of the of the pivot point if a first line defined by the center of the flash and the pivot point and a second line defined by the center of the aperture of the camera and the pivot point intersect at an angle larger than 90°. In particular, the lines can intersect at an angle of 180°. According to an exemplary embodiment of the second aspect of the present invention, the means for accommodating means for transmitting signals to be detected by means for acquiring an image are configured to accommodate the flash and the means for transmitting signals to be detected by means for acquiring an image on different sides of the of the pivot point. The flash and the means for transmitting signals to be detected by means for acquiring an image are located on different sides of the of the pivot point if a first line defined by the center of the flash and the pivot point and a second line defined by the center of the means for transmitting signals to be detected by means for acquiring an image and the pivot point intersect at an angle larger than 90°, in particular the lines can intersect at an angle of 180°. An advantage of these two embodiments is that a larger distance between the flash and the aperture of the camera or the means for transmitting signals to be detected by means for acquiring an image can be achieved as opposed to an arrangement in which the flash and the aperture of the camera or the means for transmitting signals to be detected by means for acquiring an image are provided on the same side of the pivot point. For instance, an increased distance between the flash and the aperture of the camera or the means for transmitting signals to be detected by means for acquiring an image may help to reduce the red-eye effect. This effect occurs when light emitted by the flash is reflected back to the camera or the means for acquiring an image. These reflections can be reduced by increasing the above distance, thus red-eye reduction is achieved.

According to an exemplary embodiment of the first aspect of the present invention, the second housing component is configured to accommodate an additional aperture of an additional camera. The second housing component can be configured to accommodate the aperture of the camera and the additional aperture of the additional on different sides of the pivot point. According to an exemplary embodiment of the second aspect of the present invention, the means for accommodating means for transmitting signals to be detected by means for acquiring an image are configured to accommodate additional means for transmitting signals to be detected by additional means for acquiring an image. The means for accommodating means for transmitting signals to be detected by means for acquiring an image can be configured to accommodate the means for transmitting signals to be detected by means for acquiring an image and the additional means for transmitting signals to be detected by additional means for acquiring an image on different sides of the pivot point. By providing two cameras or two means for acquiring an image, acquisition of stereoscopic images is rendered possible.

According to an exemplary embodiment of all aspects of the present invention, the absolute value of the angle included between a first pivot position and a second pivot position is 90°. An advantage of this embodiment can be that it allows a user holding the first housing component or the housing means in his hand to pivot the second housing component or the means for accommodating means for transmitting signals to be detected by means for acquiring an image from a vertical to a horizontal state.

According to an exemplary embodiment of first aspect of the present invention, in the first pivot position the aperture of the camera faces a surface portion of the first housing component and in the second pivot position the aperture protrudes over the outline of the first housing component. An advantage of this exemplary embodiment is that in the first pivot position the aperture is hidden and thus protected and in the second position the aperture is revealed and images can be acquired. According to an exemplary embodiment of second aspect of the present invention, in the first pivot position the means for transmitting signals to be detected by means for acquiring an image face a surface portion of the housing means and in the second pivot positions the means for transmitting signals to be detected by means for acquiring an image protrude over the outline of the housing means. An advantage of this exemplary embodiment is that in the first pivot position the means for transmitting signals to be detected by means for acquiring an image are hidden and thus protected and in the second position the means for transmitting signals to be detected by means for acquiring an image are revealed and images can be acquired.

According to an exemplary embodiment of all aspects of the present invention, the angle included between a first pivot position and a second pivot position is 90° and the angle included between a first pivot position and third pivot position is −90°. An advantage of this embodiment can be that the second housing component can be pivoted with respect to the first housing component to two different sides of the first pivot position, thus providing a wide scale of operating options to a user. Accordingly, with respect to the second aspect of the present invention, an advantage of this embodiment can be that the means for accommodating means for transmitting signals to be detected by means for acquiring an image can be pivoted with respect to the housing means to two different sides of the first pivot position.

According to an exemplary embodiment of the first aspect of the present invention, the angle included between a first pivot position and a second pivot position is 90° and the angle included between a first pivot position and third pivot position is −90° and in the first pivot position the aperture of the camera faces a surface portion of the first housing component, while in the second pivot position and in the third pivot position the aperture protrudes over the outline of the first housing component. An advantage of this embodiment can be that not only the aperture is protected in the first pivot position and that the aperture is revealed in the second pivot position to allow image acquisition, but that also in the third pivot position the aperture is revealed and an image can be acquired. If, for instance, the apparatus according to the first aspect of the present invention forms part of a mobile device, e.g. a mobile phone, a user may either hold the device in his left hand or in his right hand. In general, a left-handed user tends to hold such a device in his left hand, while a right-handed user tends to hold it in his right hand. If held in the right hand, it can be beneficial for a good user experience and easy handling of the device that the second housing component and the aperture protrude over a section of the outline of the first housing component limiting the first housing component to the left. Accordingly, if held in the left hand, it can be desirable that the second housing component and the aperture protrude over a section of the outline of the first housing component limiting the first housing component to the right. As in the presently described embodiments the aperture and thus the second housing component protrude over the outline of the first housing component in both the second and the third pivot position and an angle of 180° is included between the first and the second pivot position, a user can pivot the second housing component to protrude to either the left or the right side. In consequence, handling the device is equally comfortable for left-handed users and right-handed users. According to an exemplary embodiment of the second aspect of the present invention, the angle included between a first pivot position and a second pivot position is 90° and the angle included between a first pivot position and third pivot position is −90° and in the first pivot position the means for transmitting signals to be detected by means for acquiring an image face a surface portion of the housing means, while in the second pivot position and in the third pivot position the means for transmitting signals to be detected by means for acquiring an image protrude over the outline of the first housing means. Among the advantages of this embodiment are those explained above with respect to a corresponding embodiment according to the first aspect of the present invention.

In an exemplary embodiment according to the first aspect of the present invention, in a pivot position the second housing component protrudes over a first section of the outline of the first housing component and over a second section of the outline of the first housing component opposed to the first section of the outline of the first housing component. This can be beneficial in various regards. For example, if the second housing component is configured to accommodate a flash, the flash can protrude over the first section of the outline of the first housing component, while the aperture can protrude over the second section of the outline of the first housing component. Thus, a sufficiently large distance between the flash and the aperture of the camera can be realized to achieve red-eye reduction. Alternatively, for stereoscopic image acquisition, the second housing component can be configured to accommodate the aperture of the camera at a portion that protrudes over the first section of the outline of the first housing component, while the second housing component can be configured to accommodate an additional aperture of an additional camera at a portion of the second housing component that protrudes over the second section of the outline of the first housing component. In an exemplary embodiment according to the second aspect of the present invention, in a pivot position the means for accommodating means for transmitting signals to be detected by means for acquiring an image protrude over a first section of the outline of the housing means and over a second section of the outline of the housing means opposed to the first section of the outline of the housing means. Accordingly, if the means for accommodating means for transmitting signals to be detected by means for acquiring an image are configured to accommodate a flash, the flash can protrude over the first section of the outline of the housing means, while the means for transmitting signals to be detected by means for acquiring an image can protrude over the second section of the outline of the housing means. Thus, a sufficiently large distance between the flash and the means for transmitting signals to be detected by means for acquiring an image can be realized to achieve red-eye reduction. Alternatively, for stereoscopic image acquisition, the means for accommodating means for transmitting signals to be detected by means for acquiring an image can be configured to accommodate the means for transmitting signals to be detected by means for acquiring an image at a portion that protrudes over the first section of the outline of the housing means, while the means for accommodating means for transmitting signals to be detected by means for acquiring an image can be configured to accommodate additional means for transmitting signals to be detected by means for acquiring an image at a portion of the means for accommodating means for transmitting signals to be detected by means for acquiring an image that protrudes over the second section of the outline of the housing means.

According to an exemplary embodiment of first aspect of the present invention, the second housing component is configured to accommodate a user interface. According to an exemplary embodiment of the second aspect of the present invention, the means for accommodating means for transmitting signals to be detected by means for acquiring an image are configured to accommodate a user interface. Some examples of user interfaces are touch pads or touch screens, keyboards, keypads or a button. For instance, the user interface can serve for enabling a user to control the camera, e.g. adjust the zoom of the camera, or the means for acquiring an image.

According to an exemplary embodiment of all aspects of the present invention, the functionality of the user interface is variable. For example, according to an exemplary embodiment of the first aspect of the present invention, the user interface comprises keys. In a first pivot position in which the aperture of the camera protrudes over the outline of the first housing component one of the keys can serve for triggering image acquisition. On the other hand, if not in the image acquisition mode, e.g. in a second pivot position in which the aperture does not protrude over the outline of the first housing component, pressing said key can have another effect. In an embodiment the apparatus according to the first aspect of the present invention forms part of, for instance, a mobile phone and if the aperture does not protrude over the first housing component and is thus hidden, pressing said key may serve for navigating in a software menu. This is advantageous because by providing a user interface with variable or context-dependent, i.e. pivot position dependent, functionality, the number of user interfaces, or user interface elements such as keys, having only context-specific functions can be reduced. This can, for example, contribute to a comprehensible control concept of the device and possibly reduce manufacturing costs and in consequence the retail price. In another exemplary embodiment, the user interface is a touch pad serving for triggering image acquisition in the image acquisition mode and for software menu navigation otherwise. Corresponding advantages can be obtained for exemplary embodiments of an apparatus according to the second aspect of the present invention.

An exemplary embodiment of an apparatus according to the first aspect of the present invention comprises a pivot position detector, while an exemplary embodiment of an apparatus according to the second aspect of the present invention comprises means for determining the pivot position. To determine the current pivot position, a wide spectrum of solutions is available. For example, according to the first aspect of the present invention a single electrical contact can be provided on the first housing component and a plurality of electrical contacts can be provided on the second housing component. Depending on the pivot position one of the contacts provided on the second housing component is connected to the contact provided on the first housing component. An electric current can then flow trough the connected pair of contacts but not through the other contacts provided on the second housing component, thus allowing detection of the pivot position. According to the second aspect of the present invention a single electrical contact can be provided on the housing means and a plurality of electrical contacts can be provided on the means for accommodating means for transmitting signals to be detected by means for acquiring an image for pivot position determination.

In an exemplary embodiment of an apparatus according to the first aspect of the present invention, the second housing component comprises a second housing component orientation sensor, while an exemplary embodiment of an apparatus according to the second aspect of the present invention comprises means for detecting an orientation of the means for accommodating means for transmitting signals to be detected by means for acquiring an image. Such means can for instance comprise a sensor.

In an exemplary embodiment according to the first aspect of the present invention, the second housing component is configured to accommodate the user interface at a surface portion opposed to the surface portion of the second housing component configured to accommodate the aperture of a camera. An advantage of such an embodiment is that the user can operate the user interface while pointing the aperture of the camera at an object that he wants to acquire an image of. Similar advantages can be achieved by an exemplary embodiment according to the second aspect of the present invention wherein the means for accommodating means for transmitting signals to be detected by means for acquiring an image are configured to accommodate the user interface at surface portion opposed to the surface portion of the means for accommodating means for transmitting signals to be detected by means for acquiring an image configured to accommodate the means for transmitting signals to be detected by means for acquiring an image.

In an exemplary embodiment according to the first aspect of the present invention, the apparatus comprises a user interface configured to trigger image acquisition, e.g. a button, located between opposing surface portions of the first housing component and the second housing component in a hiding pivot position. In an exemplary embodiment according to the second aspect of the present invention, the apparatus comprises means for triggering image acquisition located between opposing surface portions of the housing means and the means for accommodating means for transmitting signals to be detected by means for acquiring an image in a hiding pivot position. The means for triggering image acquisition may for example comprise a button. An advantage of the above two exemplary embodiments of the present invention is that in such a pivot position if the surface portions are close to each other, the user interface configured to trigger image acquisition or the means for triggering image acquisition may be hidden. This can be beneficial if in the pivot position a device is not in an image acquisition mode and the user interface configured to trigger image acquisition or means for triggering image acquisition is in consequence not needed. By hiding the user interface configured to trigger image acquisition or the means for triggering image acquisition from a user's view in a situation of use in which it does not have a useful functionality anyway, handling of the device is simplified. Hence, the user experience can be improved. It is noted that although such a pivot position is referred to as a hiding pivot position, it is not a precondition for the embodiment presently discussed that in the hiding position the user interface configured to trigger image acquisition is hidden. The term hiding pivot position is simply intended to express that the user interface configured to trigger image acquisition can be hidden in such a pivot position, although, for example due to the spacing of the first housing component and the second housing component or the position of a user, the user interface configured to trigger image acquisition may remain at least partially visible to the user in a hiding pivot position.

In an exemplary embodiment according to the first aspect of the present invention, the first housing component is configured to accommodate a user interface. Again, any type of user interface can be employed. Providing a user interface accommodated by the first housing component can have various advantages. For instance, if a user holds the first housing component in his hand in a fixed position and then pivots the second housing component with respect to the first housing component, the position of a user interface accommodated by the first housing component will not be affected by the pivoting. Hence, the user interface can be operated independently of the pivot position. Due to this feature, usability can be improved. Similar advantages can be obtained by an exemplary embodiment according to the second aspect of the present invention in which the housing means are configured to accommodate a user interface.

In an exemplary embodiment according to the first aspect of the present invention, the first housing component is configured to accommodate the user interface at a surface portion opposed to the surface portion of the second housing component configured to accommodate the aperture of the camera. An advantage of such an embodiment is that the user can operate the user interface while pointing the aperture of the camera at an object that he wants to acquire an image of. Similar advantages can be achieved by an exemplary embodiment according to the second aspect of the present invention wherein the housing means are configured to accommodate the user interface at surface portion opposed to the surface portion of the means for accommodating means for transmitting signals to be detected by means for acquiring an image configured to accommodate the means for transmitting signals to be detected by means for acquiring an image.

In an exemplary embodiment of the first aspect of the present invention, the second housing component is configured to accommodate a display. Accordingly, in an exemplary embodiment of the second aspect of the present invention, the means for accommodating means for transmitting signals to be detected by means for acquiring an image are configure to accommodate a display.

In some embodiments of the present invention, the second housing component may encase the display completely. In this case, there can be provided a transparent portion of the second housing component that allows unobstructed viewing of the display. Such a transparent portion of the second housing component can for instance comprise a transparent plastic film. On the other hand, there can be provided a recess in the second housing component that allows the viewing area of the display to be left uncovered, thus also enabling unobstructed display observation. Accordingly, the means for accommodating means for transmitting signals to be detected by means for acquiring an image may encase the display completely. In this case, there can be provided a transparent portion of the means for accommodating means for transmitting signals to be detected by means for acquiring an image that allows unobstructed viewing of the display. Such a transparent portion of the means for accommodating means for transmitting signals to be detected by means for acquiring an image can for instance comprise a transparent plastic film. On the other hand, there can be provided a recess in the means for accommodating means for transmitting signals to be detected by means for acquiring an image that allows the viewing area of the display to be left uncovered, thus also enabling unobstructed observation the viewing area.

A display in the sense of the present application can be any kind of display notwithstanding the underlying display technology. For example, a display can be a thin film transistor liquid crystal display (TFT display). Other display technologies suitable for being employed within the context of the present invention comprise light emitting diode displays (LED displays). An advantage of TFT displays and LED displays is that they can have a comparably low thickness while providing good image quality. Cathode ray tube displays (CRT displays) can also be employed in the context of the present invention. It is also possible to provide a stereoscopic display, i.e. a display having the capability of displaying stereoscopic images. A stereoscopic display can for instance be an autostereoscopic display. Such a display is characterised by the feature that it can present stereoscopic information a viewer can perceive without the need for special glasses. A first exemplary autostereoscopic display type employs a parallax barrier to supply a viewer with different images for each of his eyes. A second exemplary autostereoscopic display type employs lenticular lens technology for this purpose. Autostereoscopic displays are convenient for users. In consequence, they are likely to benefit from good product acceptance. According to the present invention, the second housing component or the means for accommodating means for transmitting signals to be detected by means for acquiring an image may also be configured to accommodate more than one display.

Providing a display has several advantages. To name just one, a display allows displaying of images acquired by means of a camera and means for acquiring an image, respectively. An advantage of configuring the second housing component to accommodate a display is that the display can then be pivoted with respect to the first housing component together with the aperture of a camera, while an advantage of configuring the means for accommodating means for transmitting signals to be detected by means for acquiring an image to accommodate a display is that the display can then be pivoted with respect to the housing means together with the means for transmitting signals to be detected by mean for acquiring an image.

In an exemplary embodiment according to the first aspect of the present invention, the second housing component is configured to accommodate the display at a surface portion opposed to the surface portion of the second housing component configured to accommodate the aperture of a camera. An advantage of such an embodiment is that the display can then serve as an electronic viewfinder because a user can observe the display while pointing the aperture of the camera at an object that he wants to acquire an image of. Similar advantages can be achieved by an exemplary embodiment according to the second aspect of the present invention wherein the means for accommodating means for transmitting signals to be detected by means for acquiring an image are configured to accommodate the display at a surface portion opposed to the surface portion of the means for accommodating means for transmitting signals to be detected by means for acquiring an image configured to accommodate the means for transmitting signals to be detected by means for acquiring an image.

Many displays have a rectangular shape or at least a rectangular viewing area, i.e. a rectangular area the actual image is displayed on. In consequence, the array of pixels configured to form an image often has a rectangular shape, too. For example, a display may comprise an array of 640×480 Pixels (Video Graphics Array or VGA resolution), an array of 320×240 Pixels (Quarter Video Graphics Array or QVGA resolution) or 720×480 Pixels (National Television System Committee or NTSC resolution). Displays providing a comparatively small resolution such as QVGA are often used for mobile devices, while higher resolutions are used for televisions screens or computer monitors. Due the rectangular array of pixels and the rectangular shape of the viewing area, pivoting a display around an axis perpendicular to its viewing area can affect its orientation with respect to the user. For example, the display may provide QVGA resolution, i.e. 320×240 Pixels. In a first pivot position, 320 pixels are arranged in a horizontal direction and 240 Pixels are arranged in a vertical direction. In other words, in this pivot position there are 320 columns of pixels and 240 rows of pixels. Whenever in a pivot position the number of columns exceeds the number of rows, it is referred to that orientation as the horizontal mode. Pivoting the display by 90° around an axis perpendicular to the viewing area results in a transition from the horizontal mode to a vertical mode. According to the resolution discussed in the present example, in the vertical mode 240 columns and 320 rows of pixels are provided. Depending on the scenario of use of a display, users tend to prefer either the vertical or the horizontal mode. Many users for instance prefer to watch movies in a horizontal mode. Mobile devices for example may be more ergonomic in the vertical mode.

In an embodiment according to all aspects of the present invention, the content shown on the display is at least partially controlled by the orientation of the display. As described above, according to an embodiment of the present invention, the orientation of the second housing component or the of the means for accommodating means for transmitting signals to be detected by means for acquiring an image can be determined. Hence, the orientation of the display can also be determined. For example, a text passage can be shown on the display in the vertical mode. The text passage extends in a horizontal direction. When the display is pivoted to the horizontal mode, the text passage can be rotated so that it again extends in a horizontal position and thus remains easily readable. Thereby, usability is improved. Various approaches to at least partially control the image content by orientation of the display exist. For example, display control can be performed by a computer program or by an electric circuit configured to control the display based on its orientation.

As described above, in an exemplary embodiment according to all aspects of the present invention, the absolute value of the angle included between a first pivot position and a second pivot position is 90°. If the second housing component or the means for accommodating means for transmitting signals to be detected by means for acquiring an image are configured to accommodate a display, the display can also be rotated by 90°. With respect to the first aspect of the present invention and analogously applicable to the second aspect, a user holding the first housing component in one of his hands so that in the first pivot position the display is in the vertical mode can, by pivoting the second housing component by 90°, pivot the display to the horizontal mode. Two distinct pivot positions causing the display to be in the horizontal mode are available in case of embodiments wherein the angle included between a first pivot position and a second pivot position is 90° and the angle included between a first pivot position and third pivot position is −90°.

In an exemplary embodiment according to the first aspect of the present invention, at least one of the first housing component and the second housing component is configured to accommodate an actuator, the actuator being configured to pivot the first housing component and the second housing component with respect to each other. According to an exemplary embodiment of the second aspect of the present invention, at least one of the housing means and the means for accommodating means for transmitting signals to be detected by means for acquiring an image is configured to accommodate an actuator, the actuator being configured to pivot the housing means and the means for accommodating means for transmitting signals to be detected by means for acquiring an image with respect to each other. The actuator can be any type of actuator. For example, it can be a spring-loaded actuator or an electric motor. An advantage of such an embodiment can be that pivoting the first housing component and the second housing component with respect to each other can be achieved without requiring a user to perform the pivoting manually. This may improve the user experience. Pivoting may be triggered by means of a user interface. For example, by pressing a key of a key pad, an electric motor may be controlled to pivot the first housing component and the second housing component with respect to each other. Alternatively, by pressing a button, a spring-loaded actuator may be released, thereby triggering the pivoting. Corresponding advantages may be achieved for an embodiment according to the second aspect of the present invention. Automated pivoting in exemplary embodiments of the second apparatus and the third apparatus according to the first and the second aspect of the present invention may involve the use of pre-configured pivot setting selection or several actuators.

In an exemplary embodiment according to the first aspects of the present invention, the actuator is configured to pivot the first housing component and the second housing component with respect to each other by 90°. According to an exemplary embodiment of the second aspect of the present invention, the actuator is configured to pivot the housing means and the means for accommodating means for transmitting signals to be detected by means for acquiring an image with respect to each other by 90°. Thus, if the second housing component or the means for accommodating means for transmitting signals to be detected by means for acquiring an image are configured to accommodate a display, automated pivoting can serve for a transition of the display from a horizontal to a vertical mode or vice versa.

These and other aspects of the invention will be apparent from and elucidated with reference to the detailed description presented hereinafter. The features of the present invention and of its exemplary embodiments as presented above are understood to be disclosed also in all possible combinations with each other.

### BRIEF DESCRIPTION OF THE FIGURES

In the figures show:

FIG. 1a: an exemplary embodiment of a first apparatus according to all aspects of the present invention;

FIG. 1b: the apparatus of FIG. 1a in a rear view;

FIG. 1c: the apparatus depicted in FIG. 1a and FIG. 1b in another pivot position;

FIG. 2a: an exemplary embodiment of a second apparatus according to all aspects of the present invention in a first pivot position;

FIG. 2b: the second apparatus in a second pivot position;

FIG. 2c: the second apparatus in a third pivot position;

FIG. 2d: a rear view of the second apparatus in the second pivot position;

FIG. 2e: the second apparatus in a disassembled state;

FIG. 3a: a rear view of an exemplary embodiment of a third apparatus according to all aspects of the present invention in a first pivot position;

FIG. 3b: the third apparatus in a second pivot position;

FIG. 3c: the third apparatus in the second pivot position together with a cone of light emitted by a flash and a cone of light striking a lens;

FIG. 4a: a rear view of an exemplary embodiment of a fourth apparatus according to the present invention in a first pivot position;

FIG. 4b: the fourth apparatus of the present invention in a second pivot position;

FIG. 4c: the fourth apparatus of the present invention in a third pivot position;

FIG. 5: a flow chart of a first exemplary embodiment of a method according to the present invention;

FIG. 6: a flow chart of a second exemplary embodiment of a method according to the present invention.

### DETAILED DESCRIPTION OF EXEMPLARY EMBODIMENTS OF THE INVENTION

In the following detailed description of the present invention, exemplary embodiments thereof will be described in the context of mobile phones. It is however emphasized that deployment of the present invention for this type of purpose is of exemplary nature only, since the present invention is equally well suitable for various other applications. Although in the following the present invention is described with respect to the first aspect of the present invention, the exemplary embodiments can equally well be considered as embodiments according to the second aspect of the present invention. For this purpose, the first housing component can be considered as an embodiment of housing means, the second housing component can be considered as an embodiment of means for accommodating means for transmitting signals to be detected by means for acquiring an image, the aperture can be considered as means for transmitting signals to be detected by means for acquiring an image and the camera can be considered as means for acquiring an image.

Exemplary embodiments of the present invention introduce a simple single-hinge-based construction which can be used to enhance the usability of mobile devices with imaging functions and to create new value-adding functions. This concept can improve the usability of mobile imaging devices by enabling horizontal screen orientation in camera mode with single-hand activation and operation.

Exemplary embodiments of the present invention are applicable for camera phones. For good usability, especially camera phones may need a proper product concept to work. In one working mode the product needs to work as normal phone, and in another as a camera. Normal phone usage might be better with a vertical display since the phone may fit more ergonomically to a human hand, but for watching TV or taking images, a horizontal display might be better. A simple and effective construction which supports these requirements is introduced by exemplary embodiments of the present invention. These embodiments may also provide a simple and easy to use camera assembly with plural different image taking options.

As an additional function, the mechanism may provide a lens protection (from dust and scratches) mechanism for the camera and the possibility to hide a camera shooting button. Further possibilities include placing a few add-on lenses to the back cover. By using the hinge-based (revolver) product construction, images can be taken through these lenses. This way for example, macro, super-macro and zooming effects are possible. Similar add-on lens effects can be provided for the flash and it's illumination range can be extended, e.g. for zoom mode. Exemplary embodiments of the present invention provide the option to hide the camera buttons when they are not needed.

An apparatus according to some embodiments of the present invention comprises a monoblock device with one section block (folding wing part/upper block) hinged in the middle of the device. The section block can rotate 90° around an asymmetrically placed pivot axis. When the block rotates 90°, its upper part protrudes out from the normal outline of the device and reveals a camera which has been hidden at the backside of the block. As a result, a display part placed to the folding block is rotated to a horizontal position and display side buttons are formed for camera functions. The folding wing (folding block) part can have a pocket for a large size camera, e.g. a camera having optical zoom. In closed phone mode the camera lens remains protected and hidden behind a cover element which is part of the monoblock base construction (base block). The lower base part can be configured to provide good grip for a user's hand. Also the mechanism can hide the camera button when it is not needed in phone mode. Alternatively, the camera shooting button can be hidden and revealed also when the camera is activated. These embodiments may provide to the user good handling features of the product while taking images and allow the construction of simple and small devices. The parts of the device can be produced with conventional manufacturing methods. Thus, these embodiments can be advantageous with respect to manufacturing costs.

In some embodiments of the present invention, the upper block contains a camera module, display, buttons and other relevant phone electronics. They are connected to the base block through the single axis hinge with FPC or micro coaxial cables. The asymmetric hinge placement enables 90° rotation and enables convenient arrangement of the blocks in relation to each other. With 0° degrees rotation, the product is used for phone functions (phone mode and mobile mode with pocketable size of the device). and the camera remains hidden behind the back wall of the base block. Imaging mode is activated by rotating the upper block 90°. As a result the camera is revealed and the display is also rotated by 90° into landscape mode. This activation can be done with a single hand. In the imaging mode, the user can still handle the product vertically and use the side keys that are formed to one side of the display for zooming and shooting. Returning to the phone mode can also be done with a single hand by folding the block 90° to the opposite direction. Alternatively the camera shooting button can be designed to be on the side of the folding block. This way, in phone mode, also the camera button remains hidden.

In another embodiment, by placing the pivot point of the upper block to the middle on the centerline, the device can be used by left and right handed people the same way. By embedding lenses to the back cover, through which images are taken, advanced optomechanic features can be enabled, e.g. super macro or zooming. By placing an array of lenses in front of the flash, its cone can be optimized for imaging purposes. For example, a super macro lens, 2× zoom and 3× zoom combination could be used. In the zoom modes, when the shooting distance is longer, lightning range of the flash can be extended by narrowing its lightning cone. The lightning cone of the flash can be narrowed with the lens in order to increase its range for tele mode.

Moreover, in another embodiment, the camera is placed on the one end of the upper module and flash to the other. This way a larger distance between camera and flash can be obtained. It can work as a red-eye reduction method.

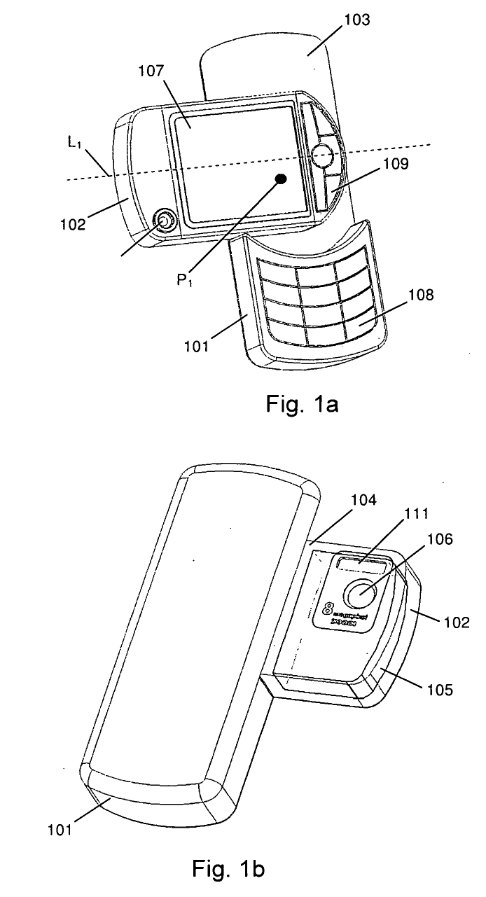

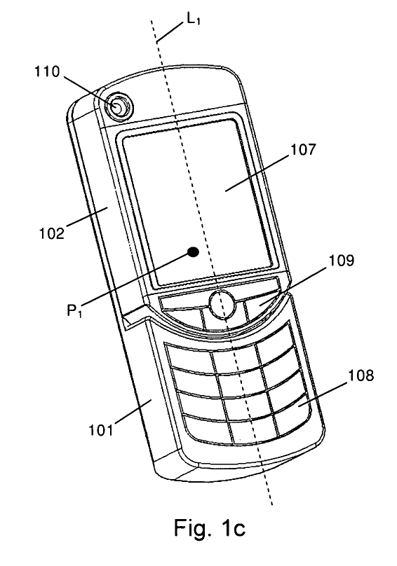

FIG. 1a illustrates an exemplary embodiment of a first apparatus according to all aspects of the present invention and FIG. 1b shows the apparatus of FIG. 1a in a rear view.

The apparatus comprises a first housing component 101 and a second housing component 102. The second housing component 102 comprises a surface portion 104 configured to accommodate the aperture 106 of the camera 105. The aperture 106 is displaced from the pivot point P₁. The surface portion 104 of the second housing component 102 which is configured to accommodate the aperture 106 of the camera 105 is configured to accommodate the flash 111 displaced from the pivot point P₁. The first housing component 101 is configured to accommodate the user interface 108 at a surface portion opposed to the surface portion 104 of the second housing component 102, while the second housing component 102 is configured to accommodate the user interface 109 at a surface portion opposed to the surface portion 104 of the second housing component 102 and configured to accommodate the display 107 at a surface portion opposed to the surface portion 104 of the second housing component 102. A camera 110 directed in the same direction as the display 107 is also provided.

Opposed to the surface portion 104 of the second housing component 102 that is configured to accommodate the aperture 106 of the camera 105, there is provided the surface portion 103 of the first housing component 101. Pivoting the first housing component 101 and the second housing component 102 with respect to each other involves a change of the arrangement of surface portion 103 and surface portion 104.

For high durability, the first housing component 101 is formed as a single part (integrally formed) and is provided with a battery (not shown) that powers the mobile phone. The second housing component 102 comprises the larger part of the phone electronics (not shown), such as electric circuits for speech signal processing and an antenna. There is enough space provided in the second housing component 102 to accommodate a comparatively large camera. Exploiting this feature, the camera 105 can have an optical zoom.

The first housing component 101 and the second housing component 102 are pivot-mounted to each other by means of a hinge (not shown) and electrically connected to each other with a FPC cable (not shown).

In the pivot position shown in FIG. 1a and FIG. 1b, the aperture 106 of the camera 105 protrudes over the outline of the first housing component 101. With the aperture 106 of the camera 105 being revealed, images can be acquired and the mobile phone is in an image acquisition mode. Thus, the illustrated pivot position is an image acquisition pivot position. Due to the placement of the pivot point P₁ with an offset to the axis of symmetry L₁ of the second housing component 102, in the pivot position depicted in FIG. 1a the second housing component 102 protrudes over a section of the outline of the first housing component 101 limiting the first housing component 101 to the left, but does not protrude over a section of the outline of the first housing component 101 limiting the first housing component 101 to the right.

If a user holds the first housing component 101 in his hand so that it extends in a vertical direction, in the pivot position shown in FIG. 1a and FIG. 1b, the second housing component 102 and the display 107 extend in a horizontal direction. In the exemplary embodiment presently discussed, the display 107 has a resolution of 320×240 Pixels (QVGA). Hence, in the horizontal mode 320 columns and 240 rows of Pixels are provided.

The functionality of the user interface 109 is variable. In an image acquisition mode, e.g. in a pivot position in which the aperture 106 of the camera 105 protrudes over the outline of the first housing component 101, the user interface 109 provides a set of display side keys. A first key of the user interface 109 may serve for controlling the optical zoom of the camera 105 to zoom in and a second key may serve for controlling the zoom of the camera 105 to zoom out. The same set of keys may serve for moving a cursor in a software menu upwards and downwards if the mobile phone is not in an image acquisition mode and the display 107 extends vertically.

FIG. 1c shows the apparatus depicted in FIG. 1a and FIG. 1b in another pivot position.

In the pivot position assumed in FIG. 1c, the second housing component 102 does not protrude over the outline of the first housing component 101. Thus, the illustrated pivot position is a basic pivot position. Compared to the pivot position illustrated in FIG. 1a and FIG. 1b, the mobile phone has a more compact shape and is thus well adapted to be put in a user's pocket or bag. Moreover, the aperture of 106 of the camera 105 faces the surface portion 103 of the first housing component 101. Hence, the illustrated pivot position is also a protection pivot position. The aperture is hidden and protected from dust and scratches.

The absolute value of the angle included between the pivot position assumed in FIG. 1a and FIG. 1b (first pivot position) and the pivot position assumed in FIG. 1c (second pivot position) is 90°. In the first pivot position the aperture 106 protrudes over the outline of the first housing component 101 and in the second pivot position the aperture 106 of the camera 105 faces a surface portion 103 of the first housing component 101. By pivoting the second housing component 102 with respect to the first housing component 101, a user can switch from the second pivot position in which the aperture 106 of the camera 105 is protected to the first pivot position in which the aperture 106 is revealed and an image acquisition mode can be assumed.

If a user holds the first housing component 101 in his hand so that it extends in a vertical direction, the second housing component 102 and the display 107 also extend vertically. Hence, in the vertical mode 240 columns and 320 rows of Pixels are provided. By pivoting the display by 90° from the second to the first pivot position, a user can switch from the vertical to the horizontal mode. As the aperture 106 of the camera 105 does not face a surface portion of the first housing component 101 in the horizontal mode, images can be acquired in the horizontal mode. The display 107 may serve as a viewfinder.

Of course, according to the present invention it is also possible to provide a first housing component that allows image acquisition in the vertical mode, i.e. the second pivot position, e.g. by arranging a recess for the aperture 106 of the camera 105 in the first housing component 101. An advantage of such an embodiment of a first housing component can be that, although the first housing component is held in a fixed position, images in a portrait format and in a landscape format can be acquired and can be shown in that format utilizing the full viewing area of the display. A user can choose the format by pivoting the second housing component.

In the embodiment of the present invention depicted in FIG. 1a, FIG. 1b and FIG. 1c, a second housing component orientation sensor (not shown) provided in the second housing component 102 allows to determinate whether the display is vertically or horizontally oriented. The content shown on the display 107 is at least partially controlled by the display orientation. For example, system information such as the percentage of the current battery charge with respect to the maximum battery charge can be provided in the upper left corner of the display, notwithstanding whether the display is in the horizontal or the vertical mode. The software running on a processor (not shown) forming part of the mobile phone assures that the numbers used to inform a user of the battery charge percentage are arrange in a horizontal direction in both the horizontal and the vertical mode.

The camera 110 can serve for video conference applications because it will face a user looking at the display 107.

For example, pivoting the first housing component 101 with respect to the second housing component 102 can be performed by a user holding the first housing component 101 in his hand by placing his thumb on the display 107, exerting a minor force thereon and then moving the thumb in the pivoting direction. Hence, operation of the mobile phone with one hand is possible.

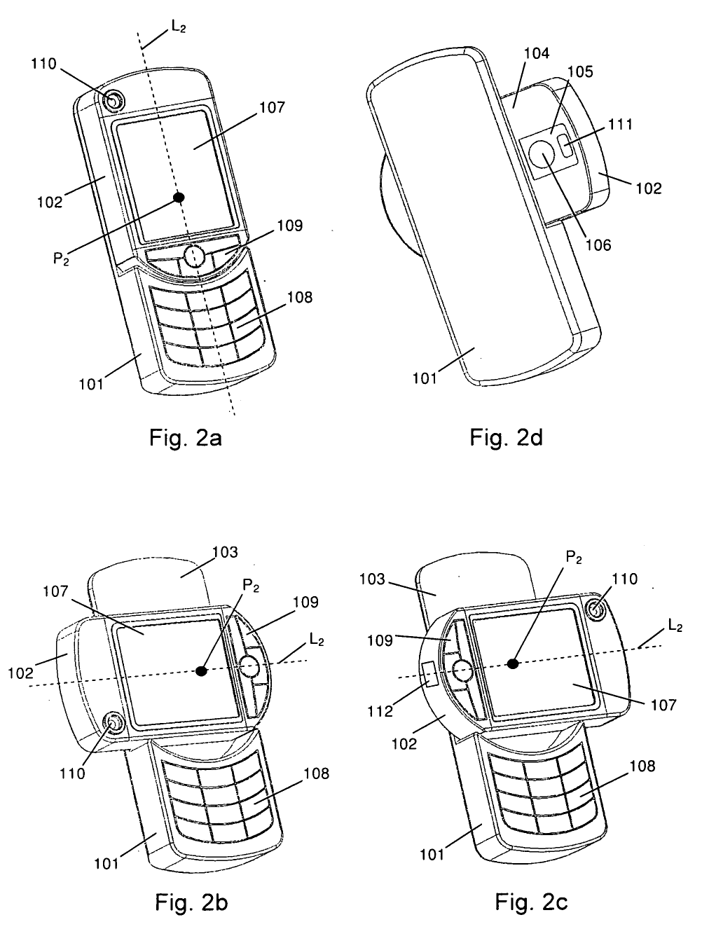

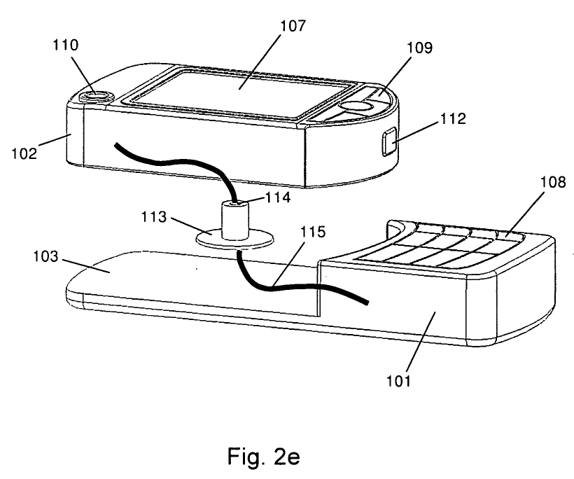

FIG. 2a shows an exemplary embodiment of a second apparatus according to all aspects of the present invention, similar to the first apparatus depicted in FIG. 1a, FIG. 1b and FIG. 1c, in a first pivot position. A description of corresponding elements is omitted.

A major difference between the first apparatus depicted in FIG. 1a, FIG. 1b and FIG. 1c and the second apparatus is the placing of the pivot point P₂. Due to the placing of the hinge (not shown) that pivot-mounts the first housing component 101 and the second housing component 102 to each other on the axis of symmetry L₂ of the first housing component 101 and the second housing component 102, the pivot point P₂ also lies on the axis of symmetry L₂ of the first housing component 101 and the second housing component 102. If a user holds the first housing component 101 in his hand so that it extends in a vertical direction, in a first pivot position shown in FIG. 2a the second housing component 102 extends vertically and the display 107 is in a vertical mode. The hinge allows pivoting of the second housing component 102 to both the left and the right side.

FIG. 2b shows the second apparatus in a second pivot position, while FIG. 2c shows it in a third pivot position.

The angle included between the first pivot position and the second pivot position in which the aperture 106 of the camera 105 protrudes over a section of the outline of the first housing component 101 limiting the first housing component to the left is 90°. In the third pivot position, the aperture 106 protrudes over a section of the outline of the first housing component 101 limiting the first housing component to the right and the angle included between the first pivot position and the third pivot position is −90°. Image acquisition can be especially comfortable for right-handed users in the second pivot position and for left-handed users in the third pivot position.

From FIG. 2c it can be derived that the mobile phone comprises a user interface configured to trigger image acquisition (button 112). The button 112 can also be considered as means for triggering image acquisition. In the first pivot position depicted in FIG. 2a, the button 112 is located between opposing surface portions of the first housing component 101 and the second housing component 102. Thus, the first pivot position can be referred to as a hiding pivot position. As the mobile phone is not in an image acquisition mode in the first pivot position, the button 112 is not needed. By hiding the button from a user's view in a situation of use in which it does not have a useful functionality anyway, handling of the device is simplified.

In the first pivot position the aperture 106 of the camera 105 faces a surface portion of the first housing component 101, while in the second pivot position and in the third pivot position the aperture 106 protrudes over the outline of the first housing component 101. In both the second and the third pivot position, the second housing component 102 protrudes over a first section of the outline of the first housing component 101 and over a second section of the outline of the first housing component 101 opposed to the first section of the outline of the first housing component 101. In other words, the second housing component 102 protrudes over both a section of the outline of the first housing component 101 limiting the first housing component 101 to the right and a section of the outline of the first housing component 101 limiting the first housing component 101 to the left. The first pivot position is a basic pivot position and a protection pivot position, while the second and the third pivot position are image acquisition pivot positions.

FIG. 2d shows a rear view of the second apparatus in the first pivot position.

FIG. 2e shows the second apparatus in a disassembled state.

In this state the hinge 113 that is used for pivot-mounting the first housing component 101 to the second housing component 102 is visible. In the hinge 113 a passage 114 is provided. Through the passage 114 a FPC cable 115 is led. It electrically connects the first housing component 101 and the second housing component 102.

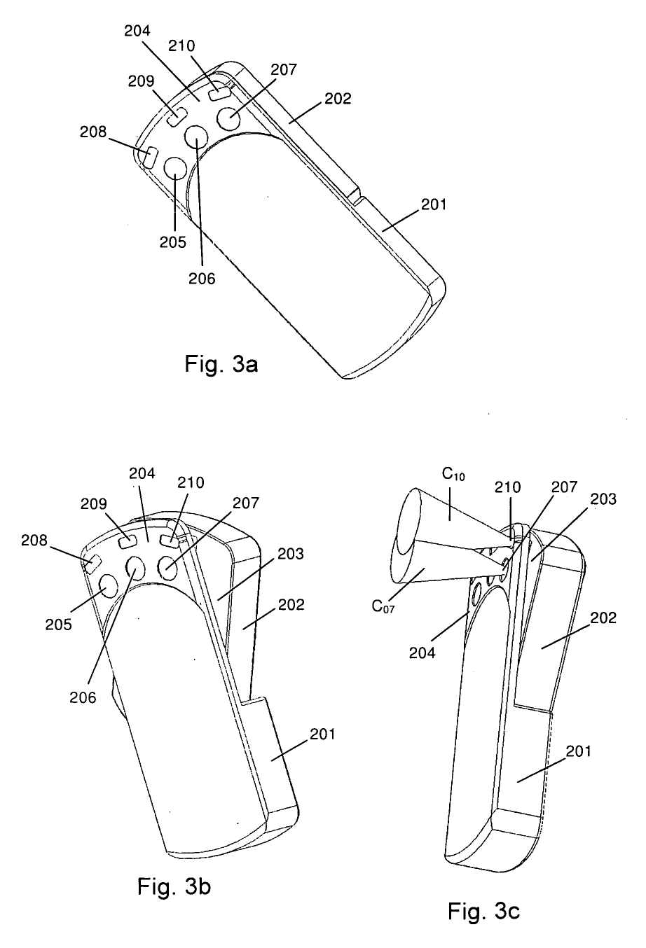

FIG. 3a shows, in a rear view, an exemplary embodiment of a third apparatus according to all aspects of the present invention, similar to the second apparatus depicted in FIG. 2a, FIG. 2b and FIG. 2c, in a first pivot position. FIG. 3b and FIG. 3c show the third apparatus in a second pivot position. FIG. 3c also exemplifies a cone of light C₁₀ emitted by a flash and a cone of light C₀₇ striking a lens 207. In the following, emphasis is placed on the differences between the second and the third apparatus.

The mobile phone depicted in FIG. 3a, FIG. 3b and FIG. 3c comprises a first housing component 201 and a second housing component 202. The second housing component 202 comprises a surface portion 203 configured to accommodate an aperture of a camera (not shown) and a flash (not shown) displaced from the pivot point.

The first housing component 201 is configured to accommodate three different lenses 205, 206 and 207 faced by the aperture in different pivot positions. Further, the first housing component 201 is configured to accommodate three lenses 208, 209 and 210 faced by the flash in different pivot positions. Lens 205 is adapted to lens 208, lens 206 is adapted to lens 209 and lens 207 is adapted to lens 210. If the aperture of the camera faces lens 205, the flash faces lens 208. Accordingly, if the aperture faces lens 206, the flash faces lens 209 and if the aperture faces lens 207, the flash faces lens 210. Lenses 205 and 208 are super macro lenses, lenses 206 and 209 are 2× zoom lenses and lenses 207 and 210 are 3× zoom lenses. A user can select a suitable lens for a given imaging task by simply pivoting the second housing component 202 with respect to the first housing component 201 so that the aperture of the camera and the flash face a fitting pair of lenses. To acquire an image of a distant object, the user may for example select lens 207 for the aperture of the camera. Then, the flash faces lens 210 as shown in FIG. 3b and FIG. 3c.

It can be derived from FIG. 3c that the 3× zoom lens 210 narrows the cone of light C₁₀ of the flash. In consequence, a distant object can be properly illuminated. 3× zoom lens 207 is used for exact focusing of incident light (cone of light C₀₇) reflected or emitted by the object of which a user wants to obtain an image.

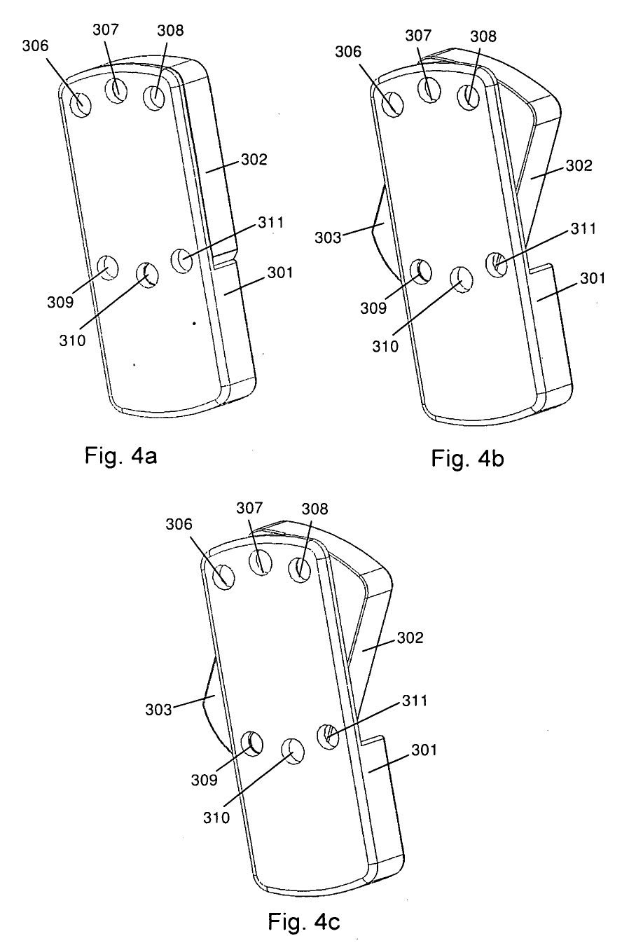

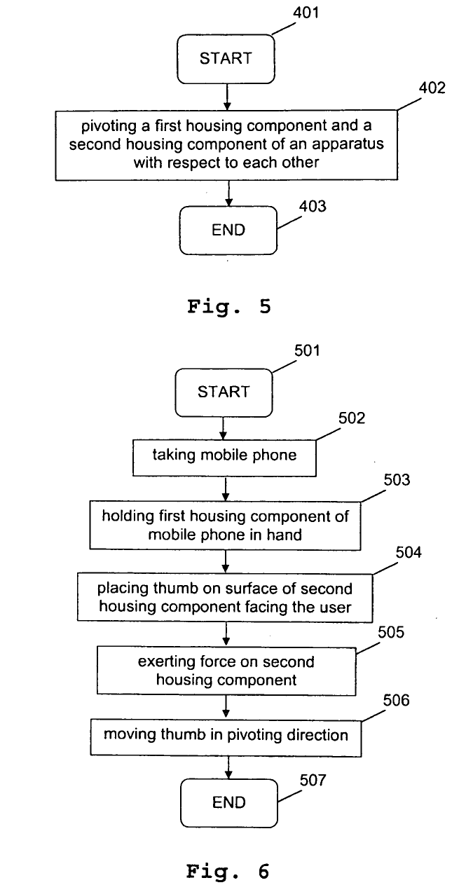

FIG. 4a shows, in a rear view, an exemplary embodiment of a fourth apparatus according to all aspects of the present invention, similar to the third apparatus depicted in FIG. 3a, FIG. 3b and FIG. 3c, in a first pivot position. FIG. 4b shows the fourth apparatus in a second and FIG. 4c in a third pivot position. In the following, emphasis is placed on the differences between the third and the fourth apparatus.

The mobile phone depicted in FIG. 4a, FIG. 4b and FIG. 4c comprises a first housing component 301 and a second housing component 302. The second housing component 302 comprises a surface portion 303 configured to accommodate an aperture 304 of a camera and a flash 305 displaced from the pivot point.

The first housing component 301 is configured to accommodate three different lenses 306, 307 and 308 faced by the aperture 304 in different pivot positions. Further, the first housing component 301 is configured to accommodate three lenses 309, 310 and 311 faced by the flash 305 in different pivot positions. Lens 306 is adapted to lens 309, lens 307 is adapted to lens 309 and lens 310 is adapted to lens 311. If the aperture of the camera faces lens 306, the flash faces lens 309. Accordingly, if the aperture faces lens 307, the flash faces lens 310 and if the aperture faces lens 308, the flash faces lens 311. Lenses 306 and 309 are macro lenses, lenses 307 and 310 are 2× zoom lenses and lenses 308 and 311 are 3× zoom lenses.

In the second pivot position (FIG. 4b) and in the third pivot position (FIG. 4c) the second housing component 302 protrudes over a first section of the outline of the first housing component 301 and over a second section of the outline of the first housing component 301 opposed to the first section of the outline of the first housing component 301.

The second housing component 302 is configured to accommodate the flash 305 and the aperture 304 of the camera on different sides of the of the pivot point.

A first imaginary line defined by the center of the flash 305 and the pivot point and a second imaginary line defined by the center of the aperture 304 of the camera and the pivot point intersect at an angle of 180°. Hence, the flash 305 and the aperture 304 of the camera are located on different sides of the of the pivot point. In the scenario illustrated in FIG. 4c, the aperture 304 is located on a surface portion of the second housing component 302 that protrudes over a first section of the outline of the first housing component 301, and the flash 305 is located on a surface portion of the second housing component 302 that protrudes over a second section of the outline of the first housing component 301. Due to the well thought-out arrangement of the flash 305 and the aperture 304, the distance d between the aperture 304 and the flash 305 is sufficiently large to help reduce the red-eye effect.

It is noted that in an embodiment of an apparatus according to the present invention similar to the fourth apparatus, the second housing component 302 can be configured to accommodate an additional aperture of an additional camera. For example, the aperture could be located at the position of flash 305 and the flash 305 could be located at another surface position of the second housing component 302. By means of the two cameras, stereoscopic images could be then acquired. If the second housing component 302 comprises a stereoscopic display, these images could be shown thereon.

It has to be understood that the provision of lenses in a manner according to that of the third or fourth apparatus can also be combined with the features of the first and the second apparatus.

FIG. 5 shows a flow chart schematically illustrating a first exemplary embodiment of a method according to the present invention.

Step 401 is the starting point. Step 402 comprises pivoting a first housing component and a second housing component of an apparatus with respect to each other by a user. The first and the second housing component are pivot-mounted to each other. The second housing component comprises a surface portion configured to accommodate an aperture of a camera, the aperture being displaced from the pivot point. Pivoting the first housing component and the second housing component with respect to each other involves a change of the arrangement of a surface portion of the first housing component opposed to the surface portion of the second housing component which is configured to accommodate the aperture of the camera. Step 403 is the end point.

FIG. 6 shows a flow chart schematically illustrating a second exemplary embodiment of a method according to the present invention.

Step 501 is the starting point. Step 502 comprises that a user takes an apparatus according to the present invention. In the present example, the apparatus is a mobile phone. It comprises a first housing component and a second housing component. The first and the second housing component are pivot-mounted to each other. At a surface portion of the second housing component, an aperture of a camera is provided. It is displaced from the pivot point.

Step 503 comprises that the user holds the first housing component in one of his hands. In step 504, the user places the thumb of the hand that holds the mobile phone on a surface portion of the second housing component. More precisely, the user places his thumb on the surface of a display arranged in the second housing component. Then, in step 505, the user exerts a force on the second housing component. By moving the thumb in the pivoting direction in step 506, the second housing component is pivoted with respect to the first housing component. Pivoting the first housing component and the second housing component with respect to each other involves a change of the arrangement of a surface portion of the first housing component opposed to the surface portion of the second housing component which is provided with the aperture of the camera. Step 507 is the end point. Pivoting of the second housing component has been performed with only one hand.

The invention has been described above by means of exemplary embodiments. It should be noted that there are alternative ways and variations which are obvious to a skilled person in the art and can be implemented without deviating from the scope and spirit of the appended claims.

What is claimed is:

1. An apparatus, comprising:
a first housing component and
a second housing component being pivot-mounted to the first housing component and comprising a surface portion configured to accommodate an aperture of a camera, the aperture being displaced from the pivot point, wherein pivoting the first housing component and the second housing component with respect to each other involves a change of the arrangement of a surface portion of the first housing component opposed to the surface portion of the second housing component which is configured to accommodate the aperture of the camera.

2. The apparatus of claim 1, characterized in that the first housing component is formed as a single part.

3. The apparatus of claim 1, characterized in that in a protection pivot position the aperture faces a surface portion of the first housing component.

4. The apparatus of claim 1, characterized in that in an image acquisition pivot position the aperture protrudes over the outline of the first housing component.

5. The apparatus of claim 1, characterized in that in a basic pivot position the second housing component does not protrude over the outline of the first housing component.

6. The apparatus of claim 1, characterized in that the second housing component is configured to accommodate a user interface.

7. The apparatus of claim 6, characterized in that the second housing component is configured to accommodate the user interface at a surface portion opposed to the surface portion of the second housing component configured to accommodate the aperture of the camera.

8. The apparatus of claim 6, characterized in that the functionality of the user interface is variable.

9. The apparatus of claim 1, characterized in that the first housing component is configured to accommodate at least one lens faced by the aperture in a pivot position.

10. The apparatus of claim 9, characterized in that the first housing component is configured to accommodate at least two different lenses faced by the aperture in different pivot positions.

11. The apparatus of claim 1, characterized in that the surface portion of the second housing component which is configured to accommodate the aperture of a camera is further configured to accommodate a flash displaced from the pivot point.

12. The apparatus of claim 11, characterized in that the first housing component is configured to accommodate at least one lens faced by the flash in a pivot position.

13. The apparatus of claim 12, characterized in that the first housing component is configured to accommodate at least two different lenses faced by the flash in different pivot positions.

14. The apparatus of claim 11, characterized in that in a pivot position the lens faced by the flash is adapted to the lens faced by the aperture in that pivot position.

15. The apparatus of claim 11, characterized in that the second housing component is configured to accommodate the flash and the aperture of the camera on different sides of the pivot point.

16. The apparatus of claim 1, characterized in that the second housing component is configured to accommodate an additional aperture of an additional camera.

17. The apparatus of claim 1, characterized in that the absolute value of the angle included between a first pivot position and a second pivot position is 90°.

18. The apparatus of claim 17, characterized in that in the first pivot position the aperture of the camera faces a surface portion of the first housing component and in the second pivot position the aperture protrudes over the outline of the first housing component.

19. The apparatus of claim 17, characterized in that the angle included between a first pivot position and a second pivot position is 90° and the angle included between a first pivot position and third pivot position is −90°.

20. The apparatus of claim 19, characterized in that in the first pivot position the aperture of the camera faces a surface portion of the first housing component, while in the second pivot position and in the third pivot position the aperture protrudes over the outline of the first housing component.

21. The apparatus of claim 4, characterized in that in a pivot position the second housing component protrudes over a first section of the outline of the first housing component and over a second section of the outline of the first housing component opposed to the first section of the outline of the first housing component.

22. The apparatus of claim 1, characterized in that it comprises a user interface configured to trigger image acquisition located between opposing surface portions of the first housing component and the second housing component in a hiding pivot position.

23. The apparatus of claim 1, characterized in that the first housing component is configured to accommodate a user interface.

24. The apparatus of claim 23, characterized in that the first housing component is configured to accommodate the user interface at a surface portion opposed to the surface portion of the second housing component configured to accommodate the aperture of the camera.

25. The apparatus of claim 1, characterized in that the second housing component is configured to accommodate a display.

26. The apparatus of claim 25, characterized in that the second housing component is configured to accommodate the display at a surface portion opposed to the surface portion of the second housing component configured to accommodate the aperture of the camera.

27. The apparatus of claim 1, characterized in that at least one of the first housing component and the second housing component is configured to accommodate an actuator, the actuator being configured to pivot the first housing component and the second housing component with respect to each other.

28. The apparatus of claim 27, characterized in that the actuator is configured to pivot the first housing component and the second housing component with respect to each other by 90°.

29. The apparatus of claim 1, further comprising a camera.

30. The apparatus of claim 25, characterized in that the second housing component comprises a second housing component orientation sensor.

31. The apparatus of claim 30, characterized in that the second housing component comprises a display and the display content is at least partially controlled by the display orientation.

32. An apparatus, comprising:
a first housing component configured to be pivot-mounted to a second housing component comprising a surface portion configured to accommodate an aperture of a camera, the aperture being displaced from the pivot point, wherein pivoting the first housing component and the second housing component with respect to each other involves a change of the arrangement of a surface portion of the first housing component opposed to the surface portion of the second housing component which is configured to accommodate the aperture of the camera.

33. An apparatus, comprising:
a second housing component configured to be pivot-mounted to a first housing component, the second housing component comprising a surface portion configured to accommodate an aperture of a camera, the aperture being displaced from the pivot point, wherein pivoting the first housing component and the second housing component with respect to each other involves a change of the arrangement of a surface portion of the first housing component opposed to the surface portion of the second housing component which is configured to accommodate the aperture of the camera.

34. An apparatus, comprising:
housing means and
means for accommodating means for transmitting signals to be detected by means for acquiring an image, the means for accommodating the means for transmitting signals to be detected by the means for acquiring an image being pivot-mounted to the housing means and comprising a surface portion configured to accommodate the means for transmitting signals to be detected by means for acquiring an image, the means for transmitting signals to be detected by means for acquiring an image being displaced from the pivot point, wherein pivoting the housing means and the means for accommodating the means for transmitting signals to be detected by the means for acquiring an image with respect to each other involves a change of the arrangement of a surface portion of the housing means opposed to the surface portion of the means for accommodating the means for transmitting signals to be detected by the means for acquiring an image which is configured to accommodate the means for transmitting signals to be detected by the means for acquiring an image.

35. A method, comprising:
pivoting a first housing component of an apparatus with respect to a second housing component of the apparatus comprising a surface portion configured to accommodate an aperture of a camera, the aperture being displaced from the pivot point and the second housing component being pivot-mounted to the first housing component, wherein pivoting the first housing component and the second housing component with respect to each other involves a change of the arrangement of a surface portion of the first housing component opposed to the surface portion of the second housing component which is configured to accommodate the aperture of the camera.
